(19) United States
(12) Patent Application Publication
(10) Pub. No.: US 2010/0082142 A1
(43) Pub. Date: Apr. 1, 2010

(54) Simulation System and Method

(76) Inventors: Adam K. Usadi, Basking Ridge, NJ (US); Nelli Fedorava, Troisk (RU); Serge Terekhov, Troisk (RU); Oleg Diyankov, Troitsk (RU); Bret L. Beckner, Houston, TX (US); Michael B. Ray, Milford, NJ (US); Ilya D. Mishev, Pearland, TX (US)

Correspondence Address: Exxon Mobil Upstream;Research Company, P.O. Box 2189, (CORP-URC-SW 359), Houston, TX, 77252-2189, US

(21) Appl. No.: 12/083,998

(22) PCT Filed: Nov. 8, 2006
(86) PCT No.: PCT/US06/43286

§ 371 Date: Nov. 6, 2009

Related U.S. Application Data
(60) Provisional application No. 60/738,860, filed on Nov. 22, 2005.

(51) Int. Cl. G06F 19/00; G06F 17/11; G06G 7/57; G06G 7/50

(52) U.S. Cl. 700/104; 703/2; 703/9; 901/50; 703/10

(57) ABSTRACT

A method and system are described that enhance the computational simulation, such as a fluid flowing through a porous media, under the present techniques. In particular, a computer implemented simulation method is described that includes initializing a simulator and utilizing an intelligent performance assistant to select a set of parameters and algorithms for the simulator. Then, equations are solved with the set of parameters and algorithms and the solution to the equations is then obtained.

This application claims the benefit of U.S. Provisional Application No. 60/738,860 filed on Nov. 22, 2005.

### BACKGROUND

1. Field of Invention

The present techniques relate to a simulation system that may be used to adaptively modify solving methods to enhance simulation runtime performance. Embodiments of the present invention generally relate to hydrocarbon simulation systems and other similar problems in computational fluid dynamics.

2. Description of Related Art

Reservoir simulation is the process of modeling fluids, energy and/or gases flowing in hydrocarbon reservoirs, wells and surface facilities. In particular, reservoir simulation is one part of reservoir modeling that includes the construction of the simulation data to accurately represent the reservoir. Accordingly, reservoir simulation is utilized to understand the flow patterns to optimize some strategy for producing hydrocarbons from some set of wells and surface facilities that access a hydrocarbon reservoir.

Because the modeling of fluids, energy and/or gases flowing in hydrocarbon reservoirs, wells, and surface facilities is complex, reservoir simulations are done using computer or modeling systems. Within the modeling systems, different applications or programs are utilized to perform calculations that model behaviors associated with the reservoirs, which may be referred to as user tools and/or simulators. The calculations performed for a simulation are usually a time consuming, iterative process that reduces uncertainty about a particular reservoir model description, while optimizing a production strategy. During the iterative process, the simulator of the modeling system may provide solutions, which may include a graphical output or report, for different periods of time for the simulation.

To provide the solutions, linear matrix solvers are used in simulations of multiphase flow through porous media. The physical model consists of a set of partial differential equations which, when discretized on a grid, form a set of equations that are solved simultaneously. See, for example, Fundamentals of Numerical Reservoir Simulation, 1991 by Don Peaceman (for example, page 33). The equations form a linear system that is solved to provide the solution to the simulation. The differences in the physical model (e.g. reservoir rock, well bore), numerical formulation (e.g. coupled implicit/CI, implicit pressure, explicit saturation/IMPES), and grid connectivity change the fundamental structure and properties of the matrix.

Solving such linear systems is a complex and challenging area of applied math and computational science. Generally, a linear system is represented by the equation Mx=b, where M is the matrix, b is the right-hand-side, and x is the vector of unknowns whose values are sought. The process of solving the equation may include “preconditioning” the matrix M to make it easier to solve, transforming the preconditioned matrix, and performing iterative methods if the solution is not accurate enough based on some threshold. As a result, the solution process becomes its own microcosm of a simulation with the total computational cost of the solver being the cumulative cost of the preconditioner, transformation, and iterative steps in the process.

Within these steps, different types of algorithms may be utilized based on the step being performed in solving the linear system. For instance, the preconditioner algorithms may include incomplete Cholesky (IC) factorization and variants of incomplete lower-upper factorization with and without fill-in ILU0, ILUK, FILU, FILUT, and the like; nested factorization; and wormed diagonal. Transformation algorithms may include scaling, such as two sided, diagonal, etc., and reordering, such as Reverse Cuthill McKee (RCM), Red-Black, and the like. Finally, the iterative algorithms may include conjugate gradient and its variants CG, CGS, BiCG, BiCGStab, etc.; minimum residual and its variants GMRES, FGRMES, QMR etc.; successive over relaxation SOR and its variants LSOR, WSOR, etc.; and/or Jacobi methods and variants Jacobi, Block-Jacobi, Point-Jacobi, etc. See, e.g., Yousef Saad, “Iterative Methods for Sparse Linear Systems,” 2000, pages 95-104. Each of these algorithms may include adjustable parameters, which affect the efficiency of the calculation and hence the computational speed of the algorithm. For example, the FILU preconditioner algorithm has two parameters, ε₁ and ε₂, that affect how much infill is used. The more infill enlarges the size of the preconditioned matrix and makes the preconditioner step more computationally expensive, but may reduce the number of iterations utilized to provide a solution. Hence, the adjustment of the parameters and algorithms may enhance the overall computational speed of the solver.

To further optimize the solver for a reservoir simulation, the selection of the different algorithms and parameters may be based on the problems faced by the linear system. While a variety of different numerical algorithms and parameters may model the same physical system, the relative runtime performance, which may include a measure of the simulation time or quality of solution, may vary. In fact, some of the numerical algorithms and parameter sets may be unable to converge and provide a solution for certain problems. Runtime performance of simulations is a function of the physical parameters of the reservoir simulation as well as numerical parameters and algorithms selected for the simulation. Accordingly, selection of the numerical algorithms and parameter sets directly affects the performance of the modeling system by changing the computations performed to provide a solution.

Typical reservoir simulators may utilize dynamic algorithms. With dynamic algorithms, the same software application is used to simulate many different physical configurations by modification of input parameters. As a result, the optimally performing parameters, which may be referred to as a parameter set, may be different for every model. In fact, the optimally performing parameters may even evolve or change during the course of simulation. Therefore, the use of a static or default parameter set in a simulator may be proper for some simulations, but may increase the number of computations for other simulations. Furthermore, effective selection of numerical algorithms and parameters is not apparent by inspection, by computational analysts, and/or by insight of an engineer using the modeling systems.

While exhaustive experimentation for a given physical model may reveal optimal parameters, the computational costs may exceed the computational savings obtained. For example, a simulation may run for five hours with default parameters. However, with optimal parameters, the simulation may run for three hours. If the experimentation utilized to determine the optimal parameters is twenty-four hours, then the computational cost of determining the optimal parameters exceeds any benefit provided by the optimal parameters.

Therefore, a need exists in the art for an improved method and system for automatically selecting parameters and algorithms that reduce the computational time to obtain a solution for a specific problem.

Other related material may be found in U.S. Pat. No. 6,882,992; U.S. Pat. No. 6,842,725; U.S. Pat. No. 6,826,520; U.S. Pat. No. 6,810,370; U.S. Pat. No. 6,799,117; U.S. Pat. No. 6,662,146; U.S. Pat. No. 6,434,435; U.S. Pat. No. 6,106,561; U.S. Pat. No. 6,088,689; U.S. Pat. No. 6,052,520; U.S. Pat. No. 6,038,556; U.S. Pat. No. 5,835,882; U.S. Pat. No. 5,392,429; U.S. Pat. No. 5,058,012; U.S. Patent Application Pub. No. 2004/133616; U.S. Patent Application Pub. No. 2002/177983; Dragojlovic Zoran et al., “A fuzzy logic algorithm for acceleration of convergence in solving turbulent flow and heat transfer problems,” Numerical Heat Transfer Part B: Fundamentals, vol. 46, no. 4, pp. 301-327 (October 2004); and Klie H et al., “Krylov-secant methods for accelerating the solution of fully implicit formulations” SPE Reservoir Simulation Symposium, SPE XP008063243, pp. 57-65, Jan. 31, 2005.

### SUMMARY

In one of the embodiment of the present techniques, a computer implemented simulation method is described, which is of fluid flow through a porous media. This method includes initializing a simulator and utilizing an intelligent performance assistant to select a set of parameters and algorithms for the simulator. Then, equations are solved with the set of parameters and algorithms. The solution to the equations is then displayed. The displayed solution represents the evolution of multiphase fluid flowing in a porous media and supports the production of hydrocarbons. In this method, the intelligent performance assistant may select the set of parameters and algorithms without user intervention. Also, the method may further include interacting with the intelligent performance assistant to provide the simulator with a different set of parameters and algorithms that enhance the runtime speed of the solving the equations; and automatically adjusting the set of parameters and algorithms with a replacement set of parameters and algorithms when runtime performance of the set of parameters and algorithms is below a specified threshold.

In another embodiment, a second computer implemented simulation method is described. This method comprises initializing a computational fluid dynamics simulation of a fluid flow model; obtaining a set of parameters and algorithms from an intelligent performance assistant to optimize runtime performance of the computational fluid dynamics simulation; solving equations in at least one numerical matrix that represent the fluid flow model with the set of parameters and algorithms; and providing a solution based on the solved equations.

In another embodiment, a method of simulating fluid flow is described. The method comprising initializing a model in a simulator; providing a set of parameters and algorithms to optimize runtime performance of a matrix solver method in a simulation, wherein the set of parameters and algorithms is selected based on a correlation between parameters that describe a numerical matrix equation and performance of the set of parameters and algorithms in comparison to a plurality of sets of algorithms and parameters used to solve the numerical matrix equation; simulating fluid flow in the model through a plurality of time steps, wherein at least one of the plurality of time steps generates the numerical matrix equation to be solved using the set of parameters and algorithms; and providing the solution to the simulation.

In another embodiment, a system for modeling fluid flow is described. The system comprises a simulation computer system having a processor and a memory comprising computer readable instructions executable by the processor and configured to: initialize a computational fluid dynamics simulation of a fluid flow model; utilize an intelligent performance assistant routine to select a set of parameters and algorithms to optimize runtime performance of the computational fluid dynamics simulation; solve equations in at least one numerical matrix that represent the fluid flow model with the set of parameters and algorithms; and provide a solution based on the solved equations. The provided solution represents the evolution of multiphase fluid flowing in a porous media and supports the production of hydrocarbons.

In another alternative embodiment, a simulation method is described. The method comprises initializing a software program to simulate performance of a physical system; selecting a set of parameters and algorithms for the software program with an intelligent performance assistant to enhance runtime performance of the simulation of the physical system; solving equations in the software program with the set of parameters and algorithms; storing a solution to the equations; and producing hydrocarbons based on the stored solution. The solution represents the evolution of multiphase fluid flowing in a porous media and supports the production of hydrocarbons.

Further, in one or more of the embodiments, the intelligent performance assistant may include an intelligent performance assistant light agent configured to receive information about a task; and to provide the set of parameters and algorithms based on the information about the task. The information about the task may include descriptors, such as one of model descriptors, machine descriptors, simulation descriptors, numerical matrixes properties of the at least one matrix solved in time steps of the computational fluid dynamics simulation, and any combination thereof. In particular, the information about the task may comprise raw runtime performance data gathered during the computational fluid dynamics simulation; one of solver preconditioners, transformation methods, tolerances and any combination thereof; one of relative preset ratings, weights, selection probabilities, and any combination thereof.

Also, in one or more of the embodiments, the intelligent performance assistant may include different mechanisms to enhance the runtime performance. For instance, the intelligent performance assistant may comprise a persistent storage mechanism having runtime performance data for a plurality of sets of parameters and algorithms, wherein the runtime performance data comprises a weighted analysis of each of the sets of parameters and algorithms; a mechanism to collect runtime performance data from the computational fluid dynamics simulation; and/or an intelligent performance assistant light agent that provides operational cartridges about the performance of the set of parameters and algorithms in solving the solution. Further, the intelligent performance assistant may interface with the simulator to report runtime performance data on the set of parameters and algorithms and to receive suggestions on other sets of parameters and algorithms to use in the solving of the equations; and to obtain runtime performance measurements from previous simulations to create a template cartridge having the set of parameters and algorithms; and to provide the template cartridge to the intelligent performance assistant.

Also, in one or more of the embodiments, the intelligent performance assistant may enhance the runtime stability of the simulation be ensuring that the solution to a particular task is of high quality. Further, the intelligent performance assistant may enhance the runtime performance of individual tasks, such as the linear solve at a specific time-step as well as the global runtime performance of the entire simulation.

### BRIEF DESCRIPTION OF THE DRAWINGS

The foregoing and other advantages of the present technique may become apparent upon reading the following detailed description and upon reference to the drawings described below.

FIG. 1 illustrates an exemplary flow chart of a simulation;

FIG. 2 illustrates an exemplary flow chart of a simulation in accordance with one embodiment of the present techniques;

FIG. 3 illustrates an exemplary embodiment of a modeling system in accordance with one embodiment of the present techniques;

FIGS. 4A-4D illustrate exemplary embodiments of cartridges utilized in the modeling system of FIG. 3 in accordance with one embodiment of the present techniques;

FIG. 5 illustrates an exemplary Intelligent Performance Assistant (IPA) light agent utilized in the modeling system of FIG. 3 in accordance with one embodiment of the present techniques;

FIG. 6 illustrates an exemplary flow chart of the use of the IPA light agent of FIG. 5 in accordance with one embodiment of the present techniques;

FIG. 7 illustrates an exemplary flow chart of a data gather process utilized in the modeling system of FIG. 3 in accordance with one embodiment of the present techniques; and

FIG. 8 illustrates an exemplary flow chart of the use of the IPA factory utilized in the modeling system of FIG. 3 in accordance with one embodiment of the present techniques.

### DETAILED DESCRIPTION

In the following detailed description section, the specific embodiments of the present techniques are described in connection with preferred embodiments. However, to the extent that the following description is specific to a particular embodiment or a particular use of the present techniques, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present techniques describe an improved method and mechanism for automatically selecting parameters and algorithms that reduce the computational time to obtain a solution for a specific problem. The method, which may be referred to herein as an Intelligent Performance Assistant (IPA), may be implemented as an exemplary embodiment that includes components, such as an IPA factory, IPA light agent and/or IPA robot, as discussed below. These components may be utilized together to enhance the performance of simulations, while the end user is not necessarily aware of the functionality of the IPA components in the modeling system. That is, the end user may follow a standard workflow for generating a simulation model, which may include executing the simulation, and analyzing the solutions or results from the simulation. When the IPA components are enabled, the different components may interact to improve the runtime performance of the simulation along with specific portions of the simulation, such as the operation of the linear solver.

Accordingly, the IPA light agent provides guidance to the simulator sub-tasks about specific algorithms and parameters to use when performing the task. It also gathers information from the simulator that may be used by other IPA components for other subsequent simulations. This “self learning” aspect of IPA is discussed in detail below. The IPA factory of the IPA system provides a mechanism for integrating new information and for providing guidance to the IPA light agent. Finally, IPA robot is an agent in a multi-model, multi-user environment that obtains new or updated information relevant to previous simulations and that may be utilized by IPA factory to refine the guidance provided.

To fully describe the functionality of the IPA components, the exemplary embodiments are directed to applications of the IPA light agent, IPA robot, and IPA factory, as applied to a linear solver in a reservoir simulator. In this type of simulator, a numerical matrix is constructed based on the model and algorithms selected for the simulation with each Newton iteration of each time-step. Because the IPA system is utilized to enhance performance of a given task (e.g. the linear solver), it includes a mechanism to gather information about actual problems arising from the task and uses this information or knowledge to improve its efficiency. For the solver, one method of the IPA system is to deduce a correlation between parameters that describe a particular matrix to the performance of particular algorithms and parameters on that matrix to enhance the process of finding optimal parameters.

Accordingly, various parameters may be collected, which may vary from simulation to simulation depending on the computational cost of computing and/or retrieving the parameters. Parameters may include model descriptors, machine descriptors, time-step descriptors, numerical matrix properties, tunable solver parameters/algorithms and/or solver performance data. Model descriptors include number of simulation domains, numerical formulation, fluid representation, and number of grid cells by physical type (reservoir rock, well or surface facility). Machine descriptors may include operating system (OS) type and central processing unit (CPU) type, CPU number, and speed. Time-step dependent descriptors, which may change every Newton or time-step iteration, may include: simulation time, simulation time step size, simulation time step attempt number, and/or simulation Newton iteration number. Numerical matrix properties may include some that are very computationally inexpensive to extract or calculate and others that are computationally expensive. Computationally inexpensive or free properties may include: number of rows, number of non-zero elements, matrix type (e.g. M-matrix or D-matrix), symmetry quality, maximal diagonal element, minimal diagonal element, maximal element, minimal element, maximal absolute value, minimal absolute value, ratio of the maximal absolute value of the non-diagonal elements of the row to the absolute value of the diagonal element computed through each of the rows in the matrix, matrix norms, number of sub-diagonal elements, number of super-diagonal elements, maximal number of non-zero elements in a row and the number of rows with this number of non-zero elements, minimal number of non-zero elements in a row and the number of rows with this number of non-zero elements, matrix bandwidth, number of structural symmetric elements, and/or matrix moments. Additional matrix properties that are more computationally expensive to calculate may include: maximal diameter, number of disjoint blocks, estimated lower-upper decomposition complexity, matrix eigenvalues and/or matrix condition number. Tunable solver parameters/algorithms may include: preconditioner algorithms, iterative methods, transformations, such as scalings and reorderings, types of smoothing, level of coarsening for multi-grid solvers, tolerances (e.g. εᵢ, ε₂), and number of saved search directions for Krylov type iterative methods. See, e.g., Saad's “Iterative Methods for Sparse Linear Systems,” 2000, pages 144-227. Solver performance data may include the number global iterations, number local/domain iterations, and/or ratio of time spent in preconditioner to iterative method. Accordingly, each of these different parameters, which may be referred to as performance measurement parameters or parameter sets, may be utilized to enhance the simulation processes, as discussed below.

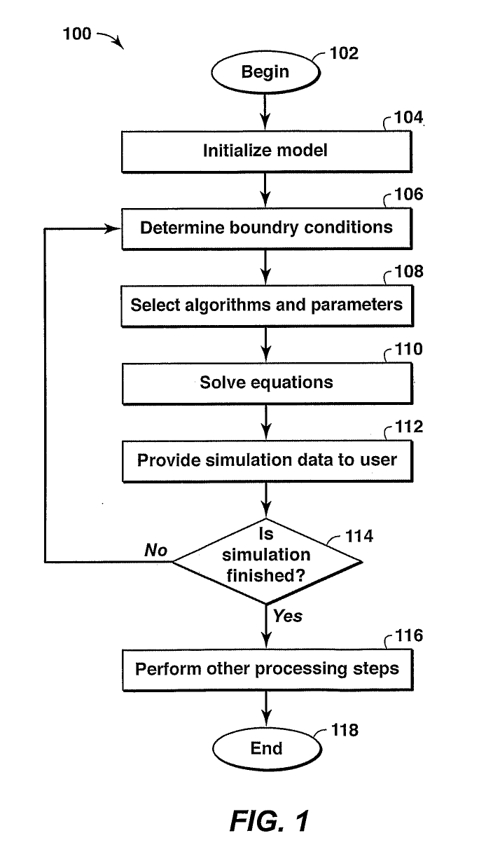

Turning to the drawings, FIG. 1 illustrates an exemplary flow diagram of process for performing a reservoir simulation. In FIG. 1, a flow diagram, which may be referenced by reference numeral 100, describes a process for performing a reservoir simulation. As noted above, reservoir simulation is the process of modeling fluids, energy, and/or gases flowing in hydrocarbon reservoirs, wells, and surface facilities. Because the reservoir simulation is utilized to model flow patterns to optimize or enhance some strategy for producing hydrocarbons from some set of wells and surface facilities, the reservoir simulation is usually a time consuming, iterative process that reduces uncertainty about particular aspects of a reservoir or fluid flow model.

The flow chart begins at block 102. At block 104, the model is initialized. The initialization process may include allocating memory for data constructs and determining the overall workflow of the simulator. The simulation itself involves the stepping or marching through time in a discrete fashion (e.g. time-stepping). The time-steps are the intervals of time over which the simulation is to be performed. At block 106, boundary conditions are set to model a physical system, which may include a one or more subsurface reservoirs, surface facilities and wells. The boundary conditions may include pressure limits (Dirichlet boundary conditions), or flow limits (Neumann boundary conditions). Then, numerical algorithms and parameters are selected to model a physical system, as shown in block 108. The selectable numerical algorithms may include formulation type, which determine the level of implicitness used to solve for the state variables, linear solver preconditioner and iterative methods, how rock compressibility is modeled, etc. Additional, adjustable parameters may be a function of the selected algorithm. For example, for the FILU preconditioner, the fill in drop tolerance is a scalar quantity generally between 0 and 1. The numerical algorithms and parameters may be selected by a user that is utilizing the simulator. As discussed above, a variety of different numerical algorithms and parameters may model the same physical system, but the relative runtime performance and quality of solution may vary based upon the selected numerical algorithms and parameters.

Then, the simulator may perform the simulation, as shown in blocks 110-112. To perform the simulation, conservation or non-linear equations that describe the fluid flow may be solved, as shown in block 110. The solving of the equations may include constructing the linear and non-linear equations, solving the linear and non-linear equations, and updating the properties and/or parameters. As discussed above, the equations are a set of partial different equations based on numerical algorithms that describe the change of state variables (e.g. fluid pressure and composition) over time subject to constraints or boundary conditions. The equations are discretized in space and are linearized over time to march the state variables forward in time. These equations may be placed in matrices and solved using solvers. When using implicit-in-time techniques the spatial discretization over a numerical grid or mesh, a sparse matrix equation is produced for each of the time steps in the time-stepping process. Then, at block 112, simulation data or solution may be provided to a user. The solution may be provided by storing the simulation data into a file, displaying a graphical output, or presenting a report to a user. The graphical outputs may be provided in the form of graphics or charts (e.g. via a graphical user interface) that may be utilized to design or enhance production capacity from one or more wells.

Then, a determination is made whether the simulation is finished, as shown in block 114. A simulation is finished when the user specified end time is reached or the user specified criteria is met. For instance, the user specified criteria may include a well operability limit being met or the simulator determines that some criteria requiring user intervention has been reached. If the simulation is not finished, the boundary conditions may be modified and equations solved again at block 106. However, if the simulation is finished, other processing steps may be performed, as shown in block 116. These other processing steps may include updating the geologic model to capture certain rock properties, refining the gridding and upscaling to include updated properties because the geologic model has finer scaling than the simulation. Regardless, the process ends at block 118.

The runtime performance of a simulation, which may include both time and quality measures, performed with the above process is a function of the physical parameters of the reservoir simulation, as well as the chosen solution algorithm. Physical parameters include rock permeability and well flow patterns, which vary for each individual field model. Furthermore, the solution algorithm usually has several adjustable parameters that control numerical aspects of the solution process. Optimizing the algorithms and parameters may allow simulations to be completed in less time. That is, adjustment of parameters and algorithms may reduce or minimize the amount of computations utilized to provide the solution.

The simulation is utilized to model the physical system to a specific accuracy with the least computational effort. In some simulations, algorithmic choices are made between computational efficiency and modeling accuracy, while other simulations may provide both if we may only find the right algorithm and control parameters. Examples of modeling selections that exhibit this trade-off include fluid representation, numerical formulation, well model and numerical grid. For instance, the fluids in a reservoir simulation may be represented as a mixture of an arbitrary number of components (e.g. 2, 3, 8 or 20). The larger the number of components, the more computationally expensive the simulation may become, but the less information the simulation may provide. Similarly, the wells may be represented mechanically, capturing details of the transient flows within the wellbore, or as simple infinitely conductive points, the later of which is computationally inexpensive. The grid utilized in the simulation may be refined (e.g. more computationally expensive) or coarsened (e.g. less computationally expensive). Finally, the selection of numerical formulation may also affect the level of implicitness obtained during the time-stepping procedure. If the physical variables are coupled closely, the simulations are more computationally expensive. For instance, if changes to the pressure in one part of the simulation are very closely tied to changes in the composition, these variables are solved simultaneously, which is computationally expensive. Within limits, the time-step control criteria or the linear and nonlinear solver methods may be modified without adversely affecting the accuracy of results, but it is not obvious by inspection which solver or time-step controls are computationally fastest for a given physical model.

The high level tasks, which are performed in block 110, may include calculating fluid properties based on the current state of the system, constructing a numerical matrix, solving this matrix equation, iterating over this solution method, etc. Furthermore, the computational costs of solving the equations iteratively and by solving the linear equations (e.g. numerical matrix equation) at each of the iterations is usually a large time consumer. The simulation may be enhanced by reducing the number of times the system performs the expensive solver call or by reducing the time spent performing each of the solver calls. The reduction of matrix solver calls may be the result of reducing the number of time step iterations, increasing the time-step size and/or decreasing the work performed inside of the matrix solver every time it is called. For example, the choice of how the sparse matrix is transformed during the solution process (e.g. scaling, sorting, algorithm, specified tolerances, etc.) may enhance the computational efficiency and reduce overall computational time even though the number of solver calls has not been reduced.

In addition, reservoir simulators and other computational fluid dynamic applications use dynamic algorithms. That is, the same software application may be used to model many different physical configurations by modifying the input data and parameters. With this type of application, the optimally performing parameter set may be different for every model. Further, as a model evolves during the course of simulation, the optimal parameter set may change. As a result, dynamic selection of optimal parameter sets over time may improve or enhance system performance compared to a single optimization at one timestep. This system performance improvement may be up to an order of magnitude compared to using static, default parameters.

To assist with a linear matrix solver, which may be utilized in block 110, an Intelligent Solver Assistant (ISA), which in one embodiment is an Intelligent Performance Assistant (IPA), may be utilized. IPA may be utilized to optimize runtime performance of more than one encapsulated task within the same simulation. Because some algorithms perform tasks in a more computationally efficient manner than others, as discussed above, the runtime performance of many simulator tasks is a complex expression of a highly non-linear system and may not be deduced analytically.

For example, the optimal parameters may be determined from exhaustive experimentation for a given model. However, exhaustive experimentation may be untenable as the computational costs may exceed any savings obtained. For example, an exhaustive series of experiments may be performed to determine the algorithms and parameters that enhance the computational efficiency for the series of matrices encountered by a specific simulation. However, the experiments provide a basis to compare the computational cost using a variety of techniques and parameters, some of which may be non-optimal. As a result, the computational costs of the exhaustive experimentation may vastly exceed the benefit gained from using optimal parameters and algorithms.

To reduce the computational costs of the experiments, the number of experiments utilized may be reduced. One method to reduce the number of required experiments is to use a DOE (design of experiments) approach. This example is discussed further below. Accordingly, the adjustment of runtime parameters is may enhance the operation of the solver.

The IPA adjusts various runtime parameters using methods of reinforcement learning and/or adaptive control to enhance the simulator's runtime performance. That is, the dynamic adjustment of the parameters may be based on performance prediction models, which include performance measurements gathered online from other simulations. The performance prediction models, which may be referred to as an IPA or IPA system, may be implemented as IPA factory, IPA light agents and IPA robots, which are discussed below, to enhance the performance of simulations.

IPA may incorporate different techniques for evolving toward optimal parameters, which utilize adaptive control and reinforcement learning. For example, techniques to perform experimentation more efficiently than a blind, exhaustive search include design of experiments (DOE), response surface methodology (RSM), and genetic search methods. DOE techniques may reduce the number of parameter adjustments performed when searching for an optimal parameter set. From the adjusted parameters, surrogate or response surface models are created and applied based on RSM to find the set of parameters that optimize the performance. See Myers, R. H. and Montgomery, D. C., Response Surface Methodology: Process and Product in Optimization Using Designed Experiments. 1st. John Wiley & Sons, Inc., pp. 1-15, 183-184 (1995). Further, a genetic search technique may also be utilized to determine optimal parameters and algorithms. The genetic search may be based on competition within a population of solutions (i.e. sets of parameters and algorithms) that provides benefits for tracking in non-stationary, noisy environments. The population of solutions may include near-optimal solutions along with optimal solutions. Because changes in the environment exert a constant selective pressure in favor of the solutions that are optimal for the current environment, the population of solutions may track a changing fitness landscape and, thus, the exploration/exploitation dilemma may be effectively resolved. Examples of IPA making use of these methods are discussed below.

Furthermore, IPA may utilize an embedded experimentation methodology. With embedded experimentation, each execution of a target task, such as solving instances of the numerical matrix, is treated as a single experiment. As the simulation evolves over time, tunable parameters may be adjusted to find an optimal parameter set. These methodologies may be more beneficial if the system evolves relatively slowly over time. The slow evolution allows parameters that are optimal for a given time-step or Newton iteration to be close to the optimal parameter set for nearby time-steps. Accordingly, the experimentation may not take too long, such as a few percent of the simulation time, and previously determined optimal parameter sets may be utilized for extended time-steps, as the simulation drifts.

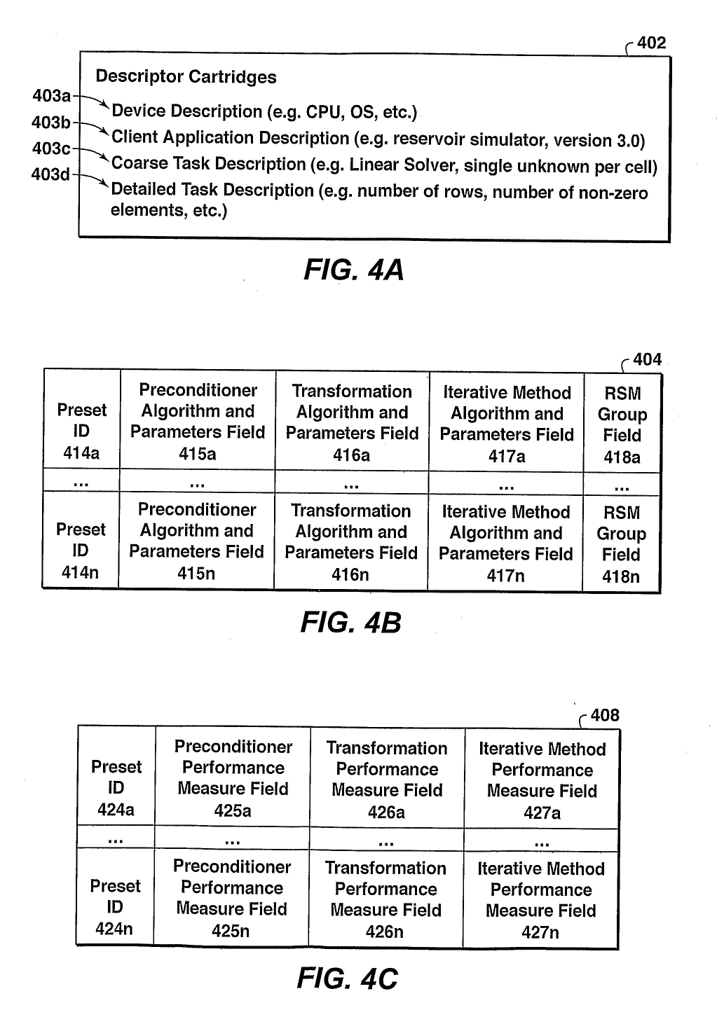

IPA may utilize a predictive methodology. For instance, for a specific calculation task, IPA may access an “encyclopedia” or database to look up the optimal parameters. This approach may avoid the computational costs of experimentation during simulations. To discover such parameters, the task may be parameterized to facilitate look-up operations. For example, with a linear solver, a simple definition may correspond to a parameter or parameter set, which uniquely describes a numerical matrix. A persistent memory of such descriptors may be called a descriptor cartridge, which is discussed below in FIGS. 4A-4D. It is the descriptive parameters that may be used to look up the optimal solution algorithms and parameters.

Regardless of the technique used to identify optimal sets of algorithms and parameters, the performance of the solution techniques is measured. Such data is indicative of the efficiency of a particular set of solution algorithms and parameters on the set of matrices generated during specific simulation models. Performance measurement may utilize algorithmic dependent parameters or elements (e.g. Newton iterations, solver iterations, time-step size) and algorithmic independent parameters or elements (e.g. CPU time, wall clock time, flops) as measurements of performance. For example, when comparing performance on similar computing hardware, CPU and wall time may be a good indicator of performance. However, when comparing simulation runs on different hardware, algorithmic comparison of solver iterations may be more useful.

Performance data mining technique may be utilized to discern relationships between performance, algorithmic choice, and activities of the simulator. Features, such as linear system matrix descriptors, convergence measures, and physical properties of simulated media, are used to create predictive control models. Because of the problem complexity, statistical entropy-based algorithms may be used to reduce feature space of the predictive control models by compressing features into manageable set of parameters, while preserving information relevant to predictive control models. Further, compression methods, which are based on data clustering, entropy elimination in decision trees, and independent component analysis with bottle-neck neural networks, may also be utilized to reduce the feature space.

With the performance data from the performance data mining technique, adaptive control and reinforcement learning techniques may be utilized to determine optimal parameters and algorithms. The techniques may utilize performance data gathered online to guide the search for optimal parameters and to adjust algorithms to gradually improve performance. Adaptive control refers to the automatic adjustment of runtime parameters, whereas reinforcement learning refers to learning systems, such as neural nets as mentioned above.

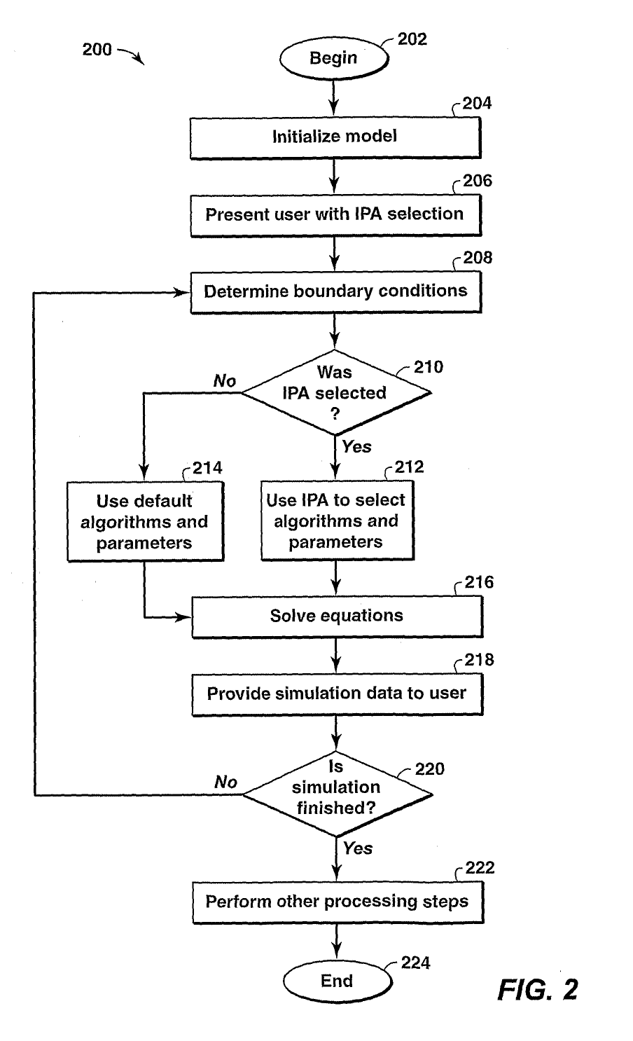

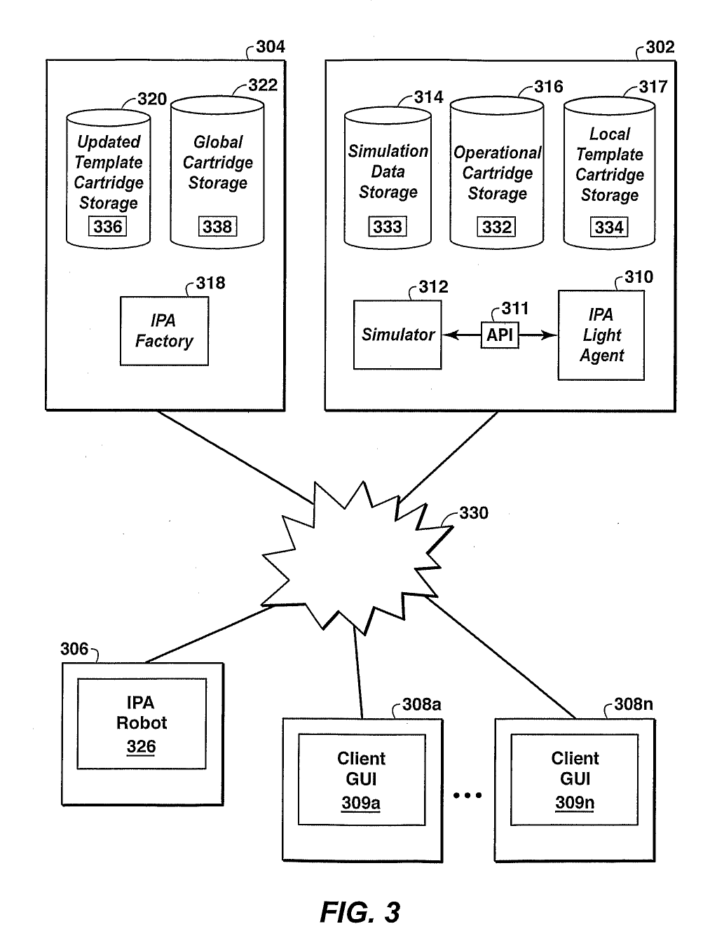

In combination, these IPA techniques may be utilized in a scheme that intelligently, automatically chooses sets of parameters and algorithms that minimize the total computational time to obtain a solution for a given problem. The use of these techniques in the IPA system is further described as a method in FIGS. 2 and 6-8 and as exemplary embodiments in FIGS. 3-5.

FIG. 2 illustrates an exemplary flow diagram of process for performing a reservoir simulation in accordance with the present techniques. In FIG. 2, an exemplary flow diagram, which may be referred to by reference numeral 200, describes a process for performing a reservoir simulation with automatic selection of a set of parameters and algorithms. Accordingly, in FIG. 2, flow simulator runtime performance may be optimized by dynamically adjusting various parameters and algorithms using the IPA techniques, discussed above.

The flow chart begins at block 202. At blocks 204, the model is initialized in a manner similar to the discussion of block 104 in FIG. 1. At block 206, the user is presented with a selection to enter algorithms and parameters or to utilize the IPA system to select the algorithms and parameters. The selection may be presented via a graphical user interface (GUI) or may be an automatic or default selection for the IPA to select the algorithms and parameters. At block 208, the boundary conditions may be determined in a manner similar to block 106 of FIG. 1. At block 210, a determination is made whether the IPA was selected. This determination may involve the simulator that is modeling the simulation accessing a memory location to obtain a flag or indicator. If IPA is selected, then algorithms and parameters are selected, as shown in block 212. This selection process, which is discussed further below, may use any of the various IPA techniques. If IPA is not selected, then the user may select the algorithms and parameters or internal simulator defaults may be used, as shown in block 214.

Regardless of the selection mechanism, the simulator may perform the simulation, as shown in blocks 216-222. To perform the simulation, the equations are solved, as shown in block 216, which may be similar to block 110 of FIG. 1. At blocks 218 and 220, the simulation data is provided to the user and a determination is made whether the simulation is finished, in a manner similar to blocks 112 and 114 of FIG. 1. If the simulation is not finished, boundary conditions may be modified again in block 208. However, if the simulation is finished, other processing steps may be performed, as shown in block 222, which may be similar to block 116 of FIG. 1. Accordingly, the process ends at block 224.

The process described above may be implemented in a modeling system, which is discussed below. Accordingly, different elements and components of an example IPA system are presented in FIG. 3. FIG. 3 illustrates an exemplary embodiment of the modeling system in accordance with one embodiment of the present techniques. The devices 302, 304, 306 and 308a-308n may be computers, servers, databases and/or a combination of these types of systems, which may also include monitors, keyboards, mouses and other user interfaces for interacting with a user. The end user may run the simulation client GUI 309a-309n on devices 308a-308n. The GUIs 309a-309n may be used to launch simulations on device 302. The simulator 312 may interact with the IPA light agent 310 via an application program interface (API) 311. Device 302 may include an IPA light agent 310 and simulator 312 along with storages 314-317 having cartridges 332-334. Device 304 may be a central knowledge server having an IPA factory 318 along with storages 322 and 324 having cartridges 336 and 338. Device 306 may include the IPA robot 326. The devices 302, 304, 306, and 308a-308n may be part of a distributed, heterogeneous computing network or may be a single machine depending on the availability of computing resources.

Because each of the devices 302, 304, 306 and 308a-308n may be located in different geographic locations, such as different offices, buildings, cities, or countries, a network 330 may be utilized to provide communication paths between the devices 302, 304, 306 and 308a-308n. The network 110, which may include different devices (not shown), such as routers, switches, bridges, for example, may include one or more local area networks, wide area networks, server area networks, metropolitan area networks, or combination of these different types of networks. The connectivity and use of the network 330 by the devices 302, 304, 306 and 308a-308n is understood by those skilled in the art.

Both the simulator 312 performing the simulation process and IPA light agent 310 may have access to persistent memory storage 314, 316, and 317, which allows different parts of IPA system to share results with each other as well as allow the user's GUI to have access to simulation results. Of course, the storage format of the simulation data and IPA related cartridge data in storages 314-317 may be any conventional type of computer readable storage device used for storing applications, which may include hard disk drives, floppy disks, CD-ROMs and other optical media, magnetic tape, and the like.

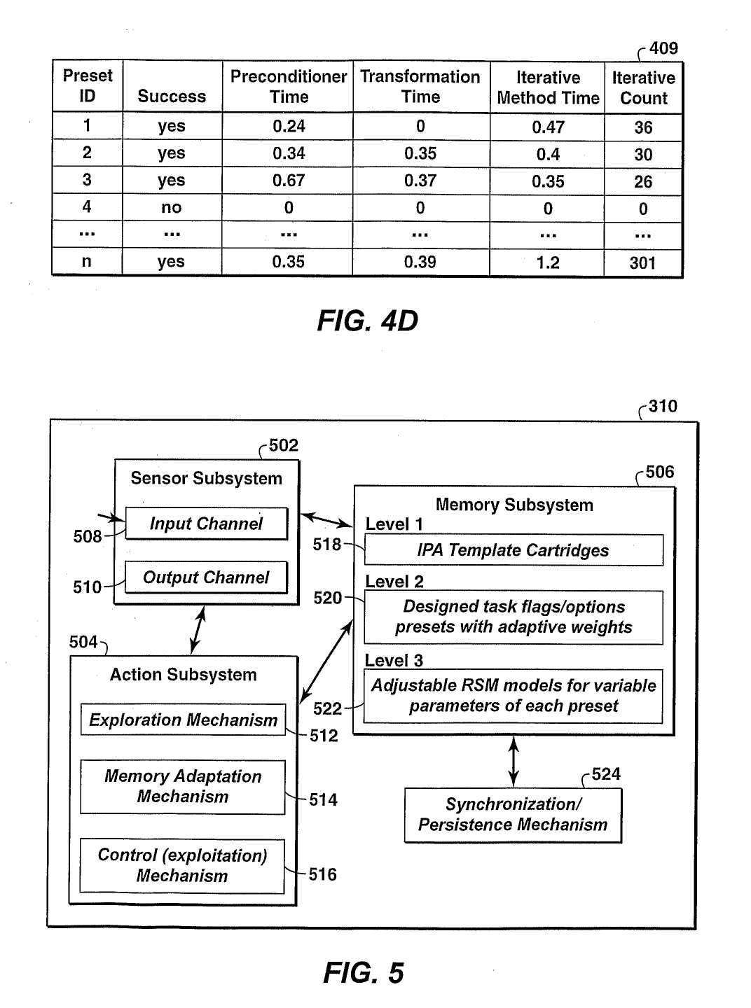

The IPA light agent 310, which is discussed further below in FIG. 5, may be an application (e.g. a routine or computer readable instructions) configured to act as an autonomous decision making agent. Accordingly, the IPA light agent 310 provides caller software, such as the simulator 312, with recommendations about optimal parameters and algorithms based on a description of the task. Also, the IPA light agent 310 collects persistent and online information about task parameters and performance information, such as CPU time and the like, of the previous task executions. The IPA light agent 310 may then modify internal neural-like adaptive memory to generate predictions of optimal algorithm parameters suitable for the task being performed or about to be performed. Data or information may be exchanged between the simulator 312 and IPA light agent 310 via function calls or other application-to-application mechanisms. The IPA light agent 310 may utilize previously generated information, such as template or operational cartridges 332 and 334, as a starting point for the automatic online adaptive control optimization and reinforcement learning.

The simulation data in the cartridge 333 may be relevant to task performance efficiency and is therefore included in the IPA system. For example, changing boundary conditions may affect the linear solver performance, but such changes may not be easily known by IPA light agent 310 and therefore may be collected by the client simulator and provided to the IPA light agent 310. The local template cartridge 334 includes information utilized to perform a reduced set of embedded experimentation relevant to the task at hand (e.g. linear solver). The operational cartridge 332 may store updated ratings, weights and response surface models obtained by IPA light agent 310 through reinforcement learning. These cartridges may be utilized in a simulation without the user having to provide parameters or algorithms (i.e. without user intervention). The cartridges 332 and 334, which are discussed further below in FIG. 4, may be files or other data structures, which include persistent memory of several aspects that is useful to the modeling system. Accordingly, the cartridges 332 and 334 may use an XML format to allow for arbitrary generalization and portability, however, this is not a functional requirement.

The IPA light agent 310 may communicate with the IPA factory 318 to exchange information about the current simulation or previous simulations, as discussed further below. The IPA factory 318 acts as a central knowledge repository or an encyclopedia for different clients that are connected via the network 330. Accordingly, IPA factory 318 includes various tools to assist in performing various tasks to manage the information provided from the IPA robots. First, the IPA factory 318 manages the storage of task parameter and algorithmic performance parameters collected by IPA robot 326, which is discussed below. This data may be stored in cartridges 338, which may be similar to the cartridges 332, in the global cartridge storage 322. Then, with this knowledge, IPA factory 318 organizes the cartridges 338 into a cluster structure or searchable task knowledge base. A cluster view on solved tasks is useful in identifying prototypical and frequently requested task types to assist in the development of more efficient template cartridges. For example, the cluster view may show that certain models produce linear matrices with common properties requiring similar sets of solution parameters to achieve optimal performance. In this way, IPA factory 318 generates new or enhanced template cartridges 336, which are stored in the updated template cartridge storage 320, based on newly acquired operational cartridges 338.

To manage the operational and simulation task cartridges from different simulations, IPA factory 318 may be a distributed human-machine system. That is, IPA factory 318 performs automated and human assisted data mining on the accumulated information or knowledge, such as operational and simulation results cartridges 338 provided from the IPA robots. The process of new template cartridge generation may include the selection of designed presets of task options and the selection of suitable RSM models for variable parameters. The selections may be performed by methodical experimentation and/or human expertise. Accordingly, IPA factory 318 may allow manual intervention.

To collect data for one or more simulator, IPA robot 326 may be activated to interact with the IPA factory 318, updated cartridge template storage 320 and global cartridge storage 322. IPA robot 326 may be an application or routine that crawls around specific storages, such as storage 316, to obtain updated information about cartridges for the IPA factory 318. In principle, this is similar to how web search engine crawlers work, which is known by those skilled in the art. IPA robot 326 is responsible for identifying new or updated operational cartridges 332 gathering information that resides in the operational cartridge templates, and providing the information to IPA factory 318.

FIGS. 4A-4D illustrate exemplary embodiments of the cartridges utilized in the modeling system 300 of FIG. 3 in accordance with one embodiment of the present techniques. Accordingly, these embodiments may be best understood by concurrently viewing FIG. 3. As noted above, various cartridges 332-338 may include various parameters and algorithms for the simulator 312 of FIG. 3. The cartridges 332-338 may be utilized to store and provide information that may be utilized to enhance the computational efficiency of the simulators, in particular, the solvers. These cartridges may include descriptor cartridges 402, template cartridges 404, and operational cartridges 408, which are each discussed below.

To begin, the descriptor cartridges 402 may be utilized to provide information about the system performing the simulation, such as the simulator 312. The descriptor cartridges 402, which may include some of the cartridges 332, may include information about the system in device description fields 403a and client application description fields 403b, such as time stamps of the current run, executable file, build configuration; versions of compiler, operating system (OS) and simulator; simulator build target; host system name; OS name; and/or central processing unit (CPU) information. In addition, the descriptor cartridges 402 may include solver runtime fields, such as coarse task description fields 403c and detailed task description fields 403d, about the solvers collected during the performance of the simulation. These solver runtime fields may include data, such as solver identification; block diagonal block indexes; number of unknowns; and/or matrix properties, such as the name of the reorder algorithm, scaling algorithm, matrix, values of normalizations, external properties, and structure elements.

As an example, the descriptor cartridge 402 may be utilized for a pressure matrix in an all implicit pressure, explicit saturation (IMPES) simulation models. This descriptor cartridge 402 may be formatted in an XML format, for exemplary purposes. The following is an example of the device descriptions.

```
<RunTimeInformation ts=“0” day=“0.00000000e+000” is_restart=“0”>
      <TimeStampCurrentRun>Oct  21  2005  17:32:57  (Central Standard
    Time)</TimeStampCurrentRun>
  <TimeStampExecutableFile>Oct 17 2005 21:39:47</TimeStampExecutableFile>
  <TimeStampBuildConfig>Oct 17 2005 19:07:20</TimeStampBuildConfig>
  <CompilerVersion>Microsoft (R) 32-bit C/C++ Optimizing Compiler Version
    2.00.8804 for 80×86</CompilerVersion>
  <SimulatorVersion>4.0</SimulatorVersion>
  <SimulatorBuildTarget>xp_opt</SimulatorBuildTarget>
  <Hostname>UPSXY8YV0C71</Hostname>
  <OS_Name>Windows-NT</OS_Name>
  <OS_Version>5.1</OS_Version>
          <CPUInfo>CPU=INTEL-Unknown  Speed=3192MHz
    Number_Available_Processors=2</CPUInfo>
</RunTimeInformation>
```

Further, an example of a detailed matrix description is shown below:

```
<solver rid=“0” ts=“0” tsa=“1” nwt=“1” day=“0.00000000e+000” dt=“1.00000000e−001”>
    <block  diag_block_index=“0” pt=“Reservoir” fm=“Impes”
    num_unknowns=“1”>36</empblock>
    <block diag_block_index=“1” pt=“well” fm=“Impes” num_unknowns=“1”>1</empblock>
</solver>
<MatrixProp>
<Reor algoname=“RCM(0)” />
<Scal algoname=“NormScaling(1,I1,col,0)” />
<Mtx name=“rid=0” isMMatrix=“0” isDDmatrix=“0” isSymmetric=“0” isStructSym=“1” />
<Dimensions rows=“37” nonz=“195” Lnonz=“79” Unonz=“116” />
<Magnitudes fmax_ii=“4.540755” fmin_ii=“4.540755” max_ij=“4.540755” min_ij=“−2.788345”
    fmax_ij=“4.540755” fmin_ij=“0.001205” frmin=“1.000000” />
<Norms LF=“19.566063” UF=“8.961253” DF=“17.386501” AF=“21.520569” Ainf=“8.100279”
    AL1=“7.000000” />
<Structure  maxElems=“7” maxElemsCount=“2” minElems=“4” minElemsCount=“6”
    maxBand=“19” maxLBand=“10” maxUBand=“10” nonsymElems=“158” noDiag=“0”
    negDiag=“0” zeroDiag=“0” smallDiag=“0” zeroOffd=“0” posOffd=“0” />
<ExtProps  MM1=“0.451970” MM2=“0.743590” MMI=“1.000000” M1=“0.559449”
    M2=“0.819747” MI=“1.000000” D1=“0.117907” D2=“0.068530” DI=“0.000000”
    Jmin=“6.346807” Jmax=“212.392718” />
</MatrixProp>.
```

Accordingly, in this example, the descriptor cartridge 402 may be utilized within the modeling system 300 to enhance other simulations based on the knowledge provided from this simulation.

Template cartridge 404 includes different algorithms and parameters that are utilized to explore and to solve the specified task. Each time a matrix equation is solved, a complete set of solution algorithms and parameters is used. It is the optimal set of these algorithms and parameters that the IPA is assisting in determining to enhance the simulation process. The presets, generated by IPA factory using DOE/RSM techniques, may have been constructed prior to the simulation, as seen in the example template cartridge 404. Alternatively, the presets may have been constructed dynamically using genetic algorithm methods where each of the sub tasks, such as preconditioner, transformer, or iterative method is considered one element of a gene. For the solver task template cartridge 404, the template cartridge may include preset identifier (ID) fields 414a-414n, preconditioner algorithm and parameter fields 415a-415n, transformation algorithm and parameter fields 416a-416n, iterative method algorithm and parameter fields 417a-417n, and RSM group fields 418a-418n. The number n, corresponding to the number of presets available in the template cartridge 404, may be determined by IPA factory 318 in the DOE/RSM case or may be indeterminate at the start of a simulation using the genetic algorithm method.

An example template cartridge 404 may be formatted in an XML for exemplary purposes. Accordingly, each of the fields 414a-418n is set forth below:

| | |
|---|---|
| <presets num=“70” | |
| p_0 =“-precond=(filu 0.001 1) -transform=( ) | -iter=(BiCGStab 1000 1e−6)” |
| p_1 =“-precond=(filu 0.001 1) -transform=(nscale row) | -iter=(BiCGStab 1000 1e−6)” |
| p_1 =“-precond=(filu 0.001 1) -transform=(nscale col) | -iter=(BiCGStab 1000 1e−6)” |

...

| | |
|---|---|
| p_21 =“-precond=(filu 0.00001 1) -transform=( ) | -iter=(BiCGStab 1000 1e−6)” |
| p_22 =“-precond=(filu 0.00001 1) -transform=(nscale row) | -iter=(BiCGStab 1000 1e−6)” |
| p_23 =“-precond=(filu 0.00001 1) -transform=(nscale col) | -iter=(BiCGStab 1000 1e−6)” |

...

| | | |
|---|---|---|
| p_44 =“-precond=(ilu 0) | -transform=( ) | -iter=(gmres 1000 50 1e−6)” |
| p_44 =“-precond=(ilu 0) | -transform=(nscale row) | -iter=(gmres 1000 50 1e−6)” |
| p_46 =“-precond=(ilu 0) | -transform=(nscale col) | -iter=(gmres 1000 50 1e−6)” |

...

| | | |
|---|---|---|
| p_66 =“-precond=(worm trans) | -transform=( ) | -iter=(gmres 1000 50 1e−6)” |
| p_67 =“-precond=(worm coef) | -transform=( ) | -iter=(gmres 1000 50 1e−6)” |
| p_68 =“-precond=(worm trans) | -transform=(acc ) | -iter=(gmres 1000 50 1e−6)” |
| p_69 =“-precond=(worm coef) | -transform=(acc ) | -iter=(gmres 1000 50 1e−6)” |

```
/>
<rsmgroups>
    0 1 2 3 4 5 6 7 8 9 10 11 12 13 14 15 16 17 18 19 20 21
    0 1 2 3 4 5 6 7 8 9 10 11 12 13 14 15 16 17 18 19 20 21
    22 23 24 25 26 27 28 29 30 31 32 33 34 35 36 37 38 39 40 41 42 43
    44 45 46 47
</rsmgroups>
<rsmpoints vars=“1” points=“3” point_0_0=“−3” point_1_0=“−5” point_2_0=“−2”>
    0 0 0 0 0 0 0 0 0 0 0 0 0 0 0 0 0 0 0 0 0 0
    1 1 1 1 1 1 1 1 1 1 1 1 1 1 1 1 1 1 1 1 1 1
    2 2 2 2 2 2 2 2 2 2 2 2 2 2 2 2 2 2 2 2 2 2
    3 3 3 3
</rsmpoints>
```

As discussed above, the genetic algorithm technique may be used to generate presets dynamically within IPA light agent 310. Hence, the template cartridge 404 may be reorganized and simplified. In this case, each sub task with more than one possible algorithm or parameters set is part of a gene. This template cartridge may be formatted in an XML format, for exemplary purposes:

```
<presets num=“38”
    gene_num=“4”
    gene_start=“ 0 12 15 35 38”
    <!-- scalings -->
    p_0=“”
    p_1=“-nscale row”
    p_2=“-nscale col”
    <!-- reorderings -->
    p_12=“”
    p_13=“-rcm 0”
    p_14=“-cbr rcm 0”
    <!-- preconditioners -->
    p_15=“-filu 1e−2 1”
    p_16=“-filu 1e−3 1”
    <!-iterative methods -->
    p_35=“BiCGStab 1000  1e−6”
    p_36=“gmres  1000 50 1e−6”
    p_37=“cg  1000  1e−6”
/>
```

Operational cartridge 408 may include performance information about different algorithms and parameters utilized in the simulation. In particular, it may include individual measures of sub tasks, such as preconditioner performance measure fields 425a-425n, transformation performance measure fields 426a-426n, and/or iterative method performance measure fields 427a-427n. Furthermore, the success of a complete preset is captured. With the performance information, the algorithms and parameters may be evaluated to determine computational time associated with providing a solution.

A specific example of detailed performance data collected, which may include averaged or gathered data, is shown in operational cartridge 409. Once again, it is formatted in an XML format for exemplary purposes:

```
<SolutionInfo problem=“matrix_properties_0”>
<!-- cost of re-ordering -->
<Reor name=“rcm” algoname=“RCM”>
  <Par name=“RootNode” val=“0” />
  <Par name=“Reverse” val=“0” />
  <Time wall=“0.000053” cpu=“0.000000” user=“0.000000”
  sys=“0.000000” />
  <Flops val=“0.000000” />
</Reor>
<!-- cost of scaling -->
<Scal name=“nscale” algoname=“NormScaling”>
  <Par name=“NormValue” val=“1.000000” />
  <Par name=“NormType” val=“1” />
  <Par name=“ScalType” val=“1” />
  <Par name=“ItersNum” val=“0” />
  <Time wall=“0.00024” cpu=“0. 00022” user=“0. 00020”
  sys=“0. 00002” />
  <Flops val=“538.000000” />
</Scal>
<!-- cost of preconditioner -->
<Prec name=“filu” algoname=“FILU”>
  <Par name=“DropTol” val=“0.001000” />
  <Par name=“DropTolFac” val=“1.000000” />
  <Par name=“FillThreshold” val=“−1” />
  <Par name=“Options” val=“0” />
  <Par name=“StripTol” val=“0.000000” />
  <Par name=“RelCoeff” val=“0.000000” />
  <Par name=“NormType” val=“4” />
  <Merit name=“Dropped” val=“135” />
  <Merit name=“DiagUpdates” val=“0” />
  <Merit name=“Ext” val=“1.082051” />
  <Time wall=“0.00089” cpu=“0. 00081” user=“0. 00080”
  sys=“0. 00001” />
  <Flops val=“1301.000000” />
</Prec>
<!-- cost of iterative method -->
<IterativeMethod name=“bicgstab” algoname=“BiCGStab”>
  <Par name=“PrecType” val=“46” />
  <Par name=“StopTol” val=“0.000100” />
  <Par name=“MaxIters” val=“1001” />
  <Par name=“StopCrit” val=“51” />
  <Par name=“ShadowRes” val=“0.000000” />
  <Merit name=“ItersNum” val=“2” />
  <Merit name=“StopTol” val=“1.606973” />
  <Merit name=“LastTol” val=“0.049290” />
  <Time wall=“0.00030” cpu=“0. 00027” user=“0. 00025”
  sys=“0. 00002” />
  <Flops val=“2978.000000” />
</IterativeMethod>
</SolutionInfo>
```

Accordingly, in this example, the operational cartridge 408 is utilized within the modeling system 300 to measure performance and evolve parameters and algorithms.

FIG. 5 illustrates an exemplary embodiment of the IPA light agent of FIG. 3 in accordance with one embodiment of the present techniques. The IPA light agent 310 may include various subsystems, such as a sensor subsystem 502, action subsystem 504 and memory subsystem 506. These subsystems 502, 504 and 506 may interact to provide recommendations about optimal parameters for tasks based on the descriptions of the tasks. Accordingly, these subsystems 502, 504 and 506 may be utilized to dynamically adjust various runtime parameters and algorithms using the IPA techniques.

The sensor subsystem 502 includes two communication channels, such as input channel 508 and output channel 510, which utilize function calls or other application-to-application mechanism. The input channel 508 receives external information, such as persistent task information (e.g. linear solver of IMPES model), variable task information (e.g. descriptor parameters), and performance information about previous executions of the task under a specific set of parameters. The caller application issues commands and queries through input channel 508 and receives recommendations through the output channel 510. For example, the simulator 312 may ask IPA light agent 310 for recommended solver parameters via the API 311. IPA light agent 310 may ask IPA factory 318 for the latest template cartridge appropriate for the current solver type of interest.

The action subsystem 504 may include three primary modes or activities: exploration mode provided by the exploration mechanism 512, adaptation mode provided by the adaptation mechanism 514 and exploitation mode provided by the control or exploitation mechanism 516. In exploration mode, IPA light agent 310 experiments or probes for new candidates of even more optimal task parameters. In adaptation mode, which may also be referred to as “learning” mode, IPA light agent 310 interacts with the intermediate level memory 520 and lowest level memory 522, which are discussed below, by training weights of presets and parameters of response surface models for each preset on latest performance measurements. During exploration mode, IPA light agent 310 enables the simulator to use previously discovered optimal parameters, while calculating the probability for reverting to exploration mode. Accordingly, simulation changes, such as a degradation of performance due to the evolution of the physical model, may trigger such an event. It should be noted that with the genetic algorithm approach, IPA light agent 310 is in an almost continuous state of exploration and adaptation modes. However, once an acceptable set of parameters is obtained in the form of a “gene,” evolution may be slow, and similar to the RSM exploitation mode.

The memory subsystem 506 may be utilized to manage predictions based on adaptive memory about specific previous experience with a solved task. The predictions may be represented by information organized into a 3-level hierarchy of adaptive neural memory, which is discussed below. These adaptation memories 518, 520 and 522 may include persistent and transient components. Accordingly, the memory subsystem 506 may also include a synchronization or persistence mechanism 524, which may be a software procedure, that synchronizes temporal and persistent memory as well as perform initializations and restarts. Persistent memory, such as the operational cartridge storage 316 and/or local template cartridge storage 317, may be utilized for storage. This persistent memory may include a current image of adaptive neural memory in the form of a cartridge and the set of pre-installed template cartridges for frequently used tasks.

The upper level or first level adaptive memory 518 refers to the template cartridge selected from the given set of template cartridges prepared and maintained by IPA factory 318. The selection of the proper template cartridge 518 is based upon the task (e.g. template cartridges corresponding to solving the matrix equation, advancing the time-step, partitioning for parallel execution). The cartridge defines the detailed parameters needed to select the proper solution method for the particular task. In general, the IPA light agent 310 acts as a client of the IPA factory 318 by sending requests for template cartridges associated with the current task being solved. The IPA template cartridges may be selected once in the beginning of a simulation run. However, it may be useful to select a new IPA cartridge template if task properties change dramatically during a simulation run.

The intermediate or second level adaptive memory 520 regulates the exploration behavior of the IPA light agent 310. In this memory 520, each specific set of tunable parameters for the controlled system (e.g. solver) is represented in the form of parameterized, complete set of algorithms and parameters for a task (i.e. a “preset”) to be performed. A subset of possible parameter combinations is pre-generated using the design of experiments (DoE) methods and is typically stored in the IPA template cartridge. Initially, the pre-generation may be performed using, for example, Latin Hypercube Sampling (LHS) methods and excluding obviously bad variants. Accordingly, different template cartridges may include different pre-generated designs.

Each preset is associated with a relative adaptive weight, which may correspond to the probability of trying it on the successive exploration step in the exploration logic 512. These adaptive weights may be adjusted based on the knowledge of the individual IPA light agents. For example, an “inexperienced” IPA light agent (i.e. one without learned experience from previous simulations) may assign equal weights for each of the presets and then starts exploration to estimate the relative performance of different presets (i.e. to rate the presets). If the IPA light agent determines that some presets provide benefits in the task performance over the other presets, it increases the weight for that preset. In its simplest form, IPA light agent uses an algorithm of weights that penalizes unproductive presets (e.g. presets that fail to complete their task or exhibit degradation in performance) and increases the weights for the productive presets. Alternatively, an “experienced” IPA light agent may store each of the preset weights in long-term memory, such as the operational cartridge storage 316 and/or local template cartridge storage 317. These weights may be useful not only during the current simulation, but also for the subsequent simulation runs on similar tasks. The “experienced” IPA light agent may use the presets with larger weights/ratings/selection probability in its exploitation logic 516.

Accordingly, various methodologies may be utilized within the second adaptation memory 520 to regulate the presets. For example, one methodology may use known presets and evaluate other presets with smaller weights/ratings only when the known presets fail to complete the task or perform below a certain level of performance. For example, with a numerical solver, a selected algorithm and parameter set may fail to converge to a solution within a time period. Another methodology may perform exploration steps with some probability ε even if the known preset operates with an acceptable performance, such as a 10 hour simulation (e.g., overnight or faster). This methodology may prevent being limited to locally optimal parameter sets, but not globally optimal parameter sets. Alternatively, a genetic search methodology may enable the presets to gradually improve the quality/fitness of the initial population of presets and automatically track slow changes in the optimized system. As a final example, a change methodology may be utilized. With this methodology, simulation code may provide the IPA light agent with indications regarding activating the exploration logic 512 (i.e. when to increase probability ε, restart a genetic search, etc.) if large changes occur in the simulation model.

Finally, the lowest level or third level adaptive memory 522 corresponds to logic that describes detailed behavior of variable parameters for each preset. Because the numerical performance of a given task, such as a numerical solver, may depend on one or more tunable parameters, the third adaptation memory 522 may adjust real-valued parameters by building RSM models. For example, the valued parameters may be the internal tolerances of a matrix fill-in scheme of a solver's preconditioner ε₁ . . . εₖ. If the solver parameters, except ε₁ . . . εₖ are fixed, the dependency (of what) may be modeled using response surface approximation, by the equation:

(t_{scale}/t)=F(ε₁ . . . εₖ|preset=n)

where “t” is a measure of the cost or time to perform the task. The optimal set of parameters ε₁ . . . εₖ corresponds to the maximum of function F. Or more generally, the optimal parameter set may correspond to the geometric center of the region where degradation of performance t_{scale}/t is above certain threshold. The threshold may be up to about 10%, or up to about 20%. The expected normalized RSM model may be pre-computed in template cartridges and adapted as new t and t_{scale} data are obtained. The current candidate models of RSM approximation are radial basis (neural network) functions (RBF) or Connectionist Normalized Local Spline neural networks (CNLS). Both models provide fast online learning of new data without significant degradation of previous function approximations.

Accordingly, the upper level adaptive memory 518 implies selecting some initial preset weights, which may be stored in a long-memory IPA template cartridge, using task descriptions. In the intermediate level adaptive memory 520, the IPA light agent performs some exploration of the task performance for the given presets and adjusts preset weights/ratings. Then, on the lowest level adaptive memory 522, the IPA light agent adjusts real-valued parameters by building RSM models.

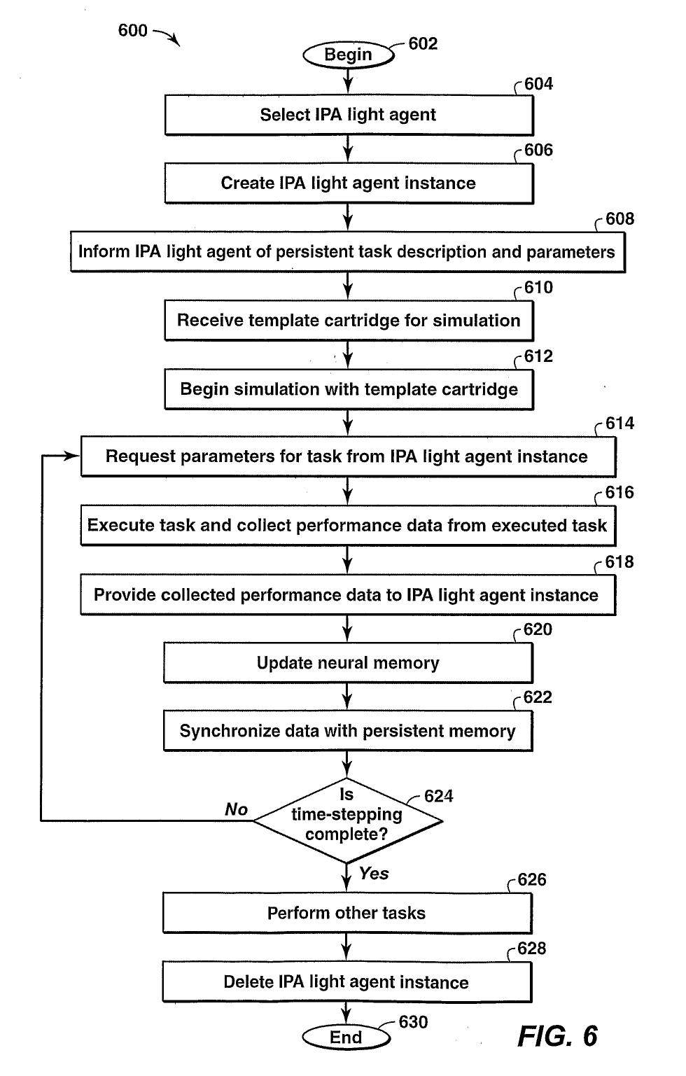

FIG. 6 illustrates an exemplary flow diagram of the use of the IPA light agent of FIG. 3 in accordance with one embodiment of the present techniques. In FIG. 6, an exemplary flow diagram, which may be referred to by reference numeral 600, describes the life cycle of the IPA light agent 310 of FIG. 3. Accordingly, FIG. 6 may be best understood by concurrently viewing FIGS. 3 and 4A-4D.

The flow chart begins at block 602. At block 604, the user of the simulator 312 selects to utilize the IPA light agent 310. This selection may be a default setting within the simulator 312 or may be a selection presented to the user through a graphical user interface. Once selected, the simulation creates an instance of the IPA light agent 310, as shown in block 606. When the instance of IPA light agent 310 is created a unique identification (ID) is associated with it. This ID may include any combination of numbers and characters that are designated by the client, which may be the simulator 312, API 311 and/or user of the simulator 312. The ID is utilized in calls to differentiate among several different IPA light agent instances. At block 608, the client, such as the simulator 312 or API 311, informs IPA light agent instance about persistent task description and parameters, as well as about the choice of operational mode, and state variables (e.g. variables which define the system, such as pressure and fluid composition). The simulator 312 may provide a descriptor cartridge that includes the system and model information. Depending on requests to IPA Factory 318 or the internal logic of the IPA light agent 310, a template cartridge, such as cartridges 402 or 404 of FIG. 4, is selected by IPA light agent 310, as shown in block 610. The template cartridge may include a cartridge created by using one of the template cartridges or an existing cartridge that has been previously loaded. The cartridges may include cartridges that are stored locally or external to the device in accessible memory, such as disk, memory, etc. To obtain the cartridges, the IPA light agent 310 may request the IPA factory 318 to provide a cartridge for the task. With the request, the IPA factory 318 may automatically retrieve and provide template cartridges for similar tasks (i.e. for tasks that have similar properties or the linear solver for matrices of IMPES formulation, as noted above) from the set of updated template cartridges 336 or global cartridges 338.

In block 612, the simulation begins to execute with the selected cartridge. In the DOE/RSM framework, the IPA light agent switches between exploration, adaptation and exploitation mode in a discontinuous fashion. In this case, the IPA light agent may initially set the exploration probability ε to 1 and reset the counter of exploration steps. Alternatively, if the simulation is a continuation of a previous run with an existing cartridge, the exploration probability ε may be set to some small value, such as about 0.05 or lower, or the probability may be derived from previously generated results. In the genetic algorithm framework, the system may explore/evolve continuously based on performance measurements encountered. At block 614, the client obtains parameters from the IPA light agent instance. To obtain the parameters, the client provides information about the task to be solved such as the type of problem and level of difficulty and requests parameters from the IPA light agent instance. The IPA light agent instance may return one of the presets (i.e. the algorithms and parameters defined in the various fields of a template cartridge 404 or 406) by taking either an exploration or exploitation step depending on current value of the exploration probability ε. Further, the IPA light agent instance may utilize predictive strategies based on the client provided information and previously derived correlations between task properties and optimal tunable parameter sets.

Then, the client may execute the task (e.g. solve the linear system) and collect performance information, as shown in block 616. It should be noted that at this time, the simulation may collect additional information to assist in training other versions of IPA factory 318. The information may be stored in persistent memory in operational cartridges having a standard cartridge storage format (e.g. XML), as discussed above. This execution of the task may include exchanging algorithms and parameters between the simulator 312 and the IPA light agent 310 as the simulation performs various iterations. At block 618, the client reports to IPA light agent instance the task's performance with the tunable parameters utilized to execute the task. In addition, some extra information about the task, such as external quality changes from previous task execution, for example, and some task state variables, if the state variables are changed on this time step or iteration. With the performance data, the IPA light agent instance collects the reported information and updates the neural memory, such as cartridges, as shown in block 620. The neural memory may include preset weights and low-level RSM models, as discussed above. It is these weights that are modified with each new set of task performance data obtained. Also, the counter of exploration steps is updated along with the exploration probability ε. The control algorithms utilized in the IPA light agent 310 may change the value of the exploration probability ε by comparing the predicted task performance and the task performance measured from the experiment. As noted above, this comparison may include other external factors, such as indications provided by the simulator 312 about iterations or clock time, for example.

At block 622, the IPA light agent instance may synchronize the current on-line version of the operational cartridge. This operation may be performed through manual intervention, such as by interacting with the user, or may be based upon a scheduled update to avoid loss of information in the event of a system crash. At block 624, the client may determine if the simulation is complete. If not, then the client may request parameters for the next set of data for the chosen task in block 614. However, if the simulation is complete, the client may perform some simulation cleanup in block 626 and delete the IPA light agent instance in block 628. Accordingly, the process ends at block 630.

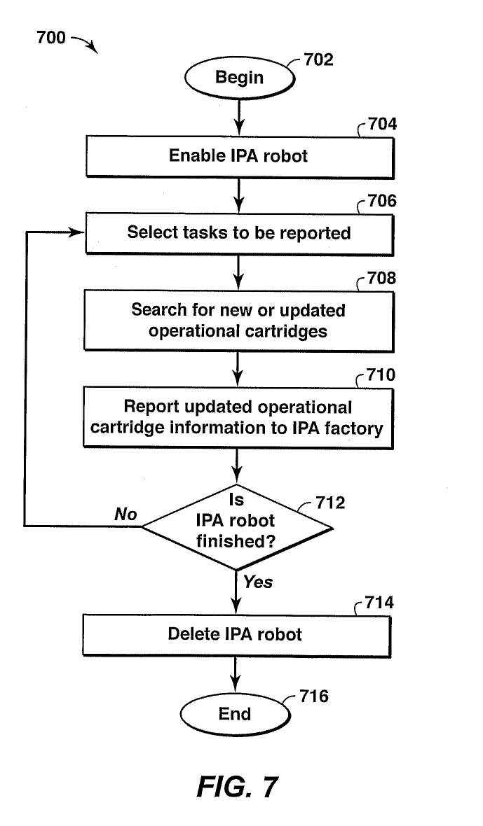

FIG. 7 illustrates an exemplary flow diagram of the data gathering process of the modeling system 300 of FIG. 3 in accordance with one embodiment of the present techniques. In FIG. 7, an exemplary flow diagram, which may be referred to by reference numeral 700, describes the data gathering process that utilizes the IPA light agent 310, IPA robot 326 and the IPA factory 318 of FIG. 3. Accordingly, FIG. 7 may be best understood by concurrently viewing FIGS. 1 and 3. The data gathering process may collect information during the run of a simulation. The collected data may be combined with other simulation data from other user tools to improve the robustness of modeling system. Also, the information collected may be utilized to enhance the neural network training of the IPA factory 318. In addition, assuming that simulations participating in the data gathering process may be scattered across many different computing domains. As a result, a variety of different domains may provide more diversity in the applications that may be utilized to enhance simulations.

The flow chart begins at block 702. At block 704, IPA robot is enabled. Typically this may be performed by administrators of the IPA system either manually or though some scheduled automated process. At this time, the tasks to be reported are specified, as shown in block 706. For example, IPA robot may be charged with gathering new operational cartridges for all linear solver tasks in each of the simulation models participating in the IPA system. Note that this option provides the end-user with the ability to opt-out or participate in the IPA data gathering system for a given simulation model by setting the appropriate flag or indication. This enables the preservation of confidentiality of contractual obligations for data associated with certain reservoirs or fields. It should be noted that end-user simulations may utilize computer systems and networks that rely on credentials and permissions derived from a network security policy to allow communication between the IPA robots and the IPA factory 318. Further, files or cartridges written by the simulator may be accessible by an administrative account that also manages the operation of the IPA robot 326.

To collect the updated task and performance data, the IPA robot 326 may access updated cartridges, as shown in block 708. As an example, the IPA robot 326 may crawl over the known/permitted directories to find updated operational cartridges. Alternatively, the IPA robot 326 may receive a notification from the simulator 312 or IPA light agent 310 when operational cartridges are updated. Regardless, relevant data is transmitted to the second device 304 that includes the IPA factory 318, as shown in block 710. IPA robot 326 may operate continuously, similar to a web crawler, which is know by those skilled in the art, or at periodic intervals as determined by the IPA system administrator. Then, the IPA robot may determine whether it is finished in block 712. This may involve using internal logic or being instructed to end its work for the given period of time after the IPA robot has gathered updated cartridge information. If the IPA robot 326 is not finished, then the simulator 312 may select other tasks to be reported in block 706. However, if the use of the IPA robot is finished, then the administrator or automated process may delete the IPA robot instance in block 714. Accordingly, the process ends at block 716.

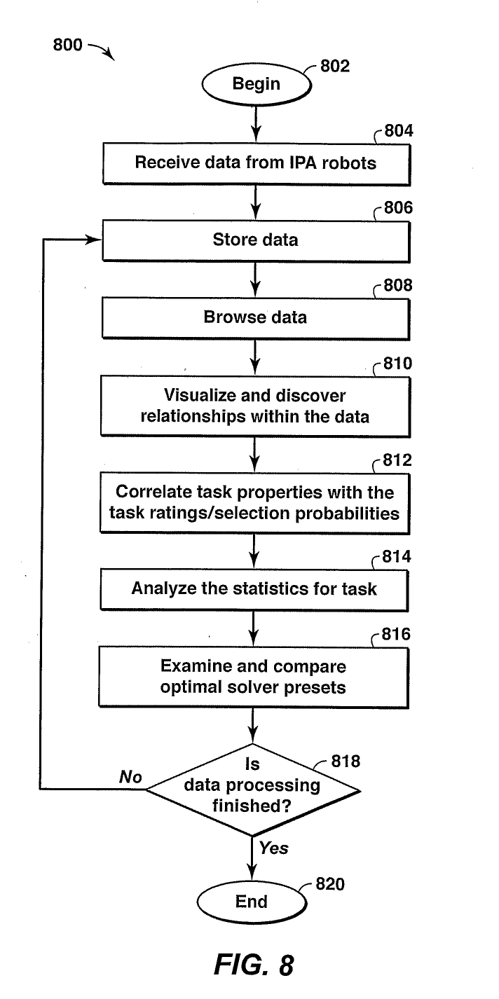

FIG. 8 illustrates an exemplary flow diagram of the use of the IPA factory of FIG. 3 in accordance with one embodiment of the present techniques. In FIG. 8, an exemplary flow diagram, which may be referred to by reference numeral 800, describes the use of the IPA factory 318 of FIG. 3 with a simulation. Accordingly, FIG. 8 may be best understood by concurrently viewing FIG. 3.

Further, it should be noted that each task in IPA factory 318 may be represented by four different data types. The first data type includes information about the task, which may include model descriptors (e.g. number of domains, fluid representation, etc.) and machine descriptors (e.g. CPU type and speed). The second data type may include time step descriptors (i.e. time step size, etc.) and numerical matrixes properties of the matrices solved in simulation time steps. The third data type may include raw runtime performance data (e.g. CPU time measurements, number of floating point operations, number of solver iterations, solver return code, etc.) gathered online during simulations assisted by IPA light agent 310 and synchronized with first and second data types. Finally, the fourth data type may include relative preset ratings, weights, and/or selection probabilities in the form of parameters. These probabilities may be obtained directly from cartridges or re-computed by IPA factory based on raw online statistics of the third data type.

The flow chart begins at block 802. At block 804, data is received from the IPA robots, such as IPA robot 326. The data may include operational cartridges collected from IPA light agents. The data is collected by the IPA factory 318 and stored into the global cartridge storage 322 in cartridges 338, as shown in block 806. Then, IPA factory 318 includes tools to browse and visualize the data collected, as shown in block 808. In particular, statistical and graphical representations of the data are useful to interact with the human component of IPA factory 318 to reduce the data and guide the data mining process in some modes.

Once the data has been browsed, various relationships may be discovered and visualized between different tasks, as shown in block 810. For example, correlations between descriptive parameters or between a descriptive parameter, solver parameter, and performance may be utilized. This may be achieved by applying standard clustering techniques, such as K-means, self organizing map (SOM), etc. At block 812, the task properties may be correlated with task rating/selection probabilities. For instance, correlations between task properties of the first and second data type and task preset ratings/selection probabilities of the fourth data type may be visualized. This may, for example, include comparing the matrix scalar properties with the tunable solver parameter presets. Then, for a selected task, off-line post factum analysis of runtime statistics of the second data type is performed and approximation models, such as response surfaces, are built and visualized. For example, consider the average solver performance response (e.g. CPU time) compared with the solver preset. At block 814, analysis of the statistics for a task may be performed. This may include off-line post factum analysis of runtime statistics of the second data type for a specific task. This analysis may find solver presets that provide robust near-optimal solver performance for that task. Then, the optimal solver preset may be examined and compared with the solution found by IPA light, as shown in block 816.

With the optimal solver presets determined, the IPA factory 318 may determine if the data processing is finished, as shown in block 818. If the data processing is not finished, the IPA factory may continue to receive data from the same or other IPA robots. However, if the data processing is finished, the process may end at block 820.

As an alternative embodiment, it should be noted that the simulator 312, IPA light agent 310, IPA factory 318 and IPA robot 326 may reside in memory of the same device as applications along with respective storages or storage devices 314, 316, 317, 322 and 324. The simulator 312, IPA light agent 310, IPA factory 318 and IPA robot 326 may be implemented as databases, programs, routines, software packages, or additional computer readable software instructions in an existing programs, which may be written in a computer programming language, such as C++, Java, Matlab scripts and the like. Further, the storage devices 314, 316, 317, 322 and 324 may be of any conventional type of computer readable storage device used for storing applications, which may include hard disk drives, floppy disks, CD-ROMs and other optical media, magnetic tape, and the like.

While the present embodiments have been described in relation to reservoir simulations, it should be noted the class of computational fluid dynamics problems in reservoir simulations shares many algorithmic and numerical techniques with other applications. For instance, the present techniques may be utilized for environmental applications, such as ground water modeling. In addition, the present techniques may be utilized for aerospace applications, such as air flowing over a wing. As such, it should be appreciated that the present techniques may be utilized to further enhance other modeling applications.

While the present techniques of the invention may be susceptible to various modifications and alternative forms, the exemplary embodiments discussed above have been shown only by way of example. However, it should again be understood that the invention is not intended to be limited to the particular embodiments disclosed herein. Indeed, the present techniques of the invention include all alternatives, modifications, and equivalents falling within the true spirit and scope of the invention as defined by the following appended claims.

What is claimed is:

1. A computer implemented simulation method comprising:
initializing a computational fluid dynamics simulation of a fluid flow model;
obtaining a set of parameters and algorithms from an intelligent performance assistant to optimize runtime performance of the computational fluid dynamics simulation;
solving equations in at least one numerical matrix that represent the fluid flow model with the set of parameters and algorithms; and
providing a solution based on the solved equations.

2. The method of claim 1 wherein the intelligent performance assistant obtains the set of parameters and algorithms without user intervention.

3. The method of claim 1 wherein the runtime performance comprises computational time associated with a linear solve of the at least one numerical matrix at a specific time-step.

4. The method of claim 1 wherein the runtime performance comprises computational time associated with the entire computational fluid dynamics simulation.

5. The method of claim 1 wherein the runtime performance comprises a measurement of the quality of the solution.

6. The method of claim 1 wherein the computational fluid dynamics simulation models fluid flow through porous media from a subsurface reservoir through one or more wells to a surface facility.

7. The method of claim 1 further comprising interacting with the intelligent performance assistant to provide the computational fluid dynamics simulation with a different set of parameters and algorithms that enhance the runtime performance of the computational fluid dynamics simulation.

8. The method of claim 1 further comprising automatically adjusting the set of parameters and algorithms with a replacement set of parameters and algorithms when the runtime performance of the set of parameters and algorithms is below a specified threshold.

9. The method of claim 1 further comprising displaying the solution on a graphical user interface.

10. The method of claim 1 wherein the intelligent performance assistant comprises an intelligent performance assistant light agent configured to:
receive information about a task; and
provide the set of parameters and algorithms based on the information about the task.

11. The method of claim 10 wherein the information about the task comprises one of model descriptors, machine descriptors, simulation descriptors, numerical matrixes properties of the at least one numerical matrix solved in time steps of the computational fluid dynamics simulation, and any combination thereof.

12. The method of claim 10 wherein the information about the task comprises raw runtime performance data gathered during the computational fluid dynamics simulation.

13. The method of claim 10 wherein the information about the task comprises one of solver preconditioners, transformation methods, tolerances and any combination thereof.

14. The method of claim 10 wherein the information about the task comprises one of relative preset ratings, weights, selection probabilities, and any combination thereof.

15. The method of claim 10 wherein the intelligent performance assistant comprises an intelligent performance assistant factory that is configured to:
utilize performance measurements from previous simulations to create a template cartridge having the set of parameters and algorithms; and
provide the template cartridge to the intelligent performance assistant light agent.

16. The method of claim 1 wherein the intelligent performance assistant comprises a persistent storage mechanism having runtime performance data for a plurality of sets of parameters and algorithms, wherein the runtime performance data comprises a weighted analysis of each of the sets of parameters and algorithms.

17. The method of claim 1 further comprising interfacing with the intelligent performance assistant to report runtime performance data on the set of parameters and algorithms and receive suggestions on other sets of parameters and algorithms to use in the solving of the equations.

18. The method of claim 1 further comprising interacting with the intelligent performance assistant to obtain runtime performance measurements from previous simulations to create a template cartridge having the set of parameters and algorithms; and to provide the template cartridge to the intelligent performance assistant.

19. The method of claim 1 wherein the intelligent performance assistant comprises a mechanism to collect runtime performance data from the computational fluid dynamics simulation.

20. The method of claim 1 wherein the intelligent performance assistant comprises an intelligent performance assistant light agent that provides operational cartridges about the performance of the set of parameters and algorithms in solving the solution.

21. The method of claim 20 wherein the intelligent performance assistant comprises:
an intelligent performance assistant robot and an intelligent performance assistant factory, wherein the intelligent performance assistant robot is configured to:
obtain operational cartridges from the intelligent performance assistant light agent; and
provide the operational cartridges to the intelligent performance assistant factory; and
the intelligent performance assistant factory is configured to:
sort the set of parameters and algorithms with other sets of parameters and algorithms; and
create updated template cartridges for the intelligent performance assistant light agent to access.

22. The method of claim 1 comprising producing hydrocarbons based on the displayed solution.

23. A system for modeling fluid flow comprising:
a simulation computer system comprising:
a processor; and
a memory comprising computer readable instructions executable by the processor and configured to:
initialize a computational fluid dynamics simulation of a fluid flow model;
utilize an intelligent performance assistant routine to select a set of parameters and algorithms to optimize runtime performance of the computational fluid dynamics simulation;
solve equations in at least one numerical matrix that represent the fluid flow model with the set of parameters and algorithms; and
provide a solution based on the solved equations.

24. The system of claim 23 wherein the intelligent performance assistant routine selects the set of parameters and algorithms without user intervention.

25. The system of claim 23 wherein the computational fluid dynamics simulation models fluid flow from a subsurface reservoir through one or more wells to a surface facility.

26. The system of claim 23 wherein the computer readable instructions are configured to automatically adjust the set of parameters and algorithms with a replacement set of parameters and algorithms when the set of parameters and algorithms is determined to be below a performance threshold.

27. The system of claim 23 further comprising displaying the solution on a graphical user interface.

28. The system of claim 23 wherein the intelligent performance assistant routine comprises an intelligent performance assistant light agent configured to:
receive information about a task;
provide the set of parameters and algorithms based on the information about the task.

29. The system of claim 28 comprising:
a knowledge computer system coupled to the simulation computer system via a network, wherein the knowledge computer system comprises:
a processor; and
memory coupled to the processor and having an intelligent performance assistant factory routine executable by the processor and configured to:
interact with another computer coupled to the simulation computer system via the network and comprising an intelligent performance assistant factory routine that is configured to:
utilize performance measurements from previous simulations to create a template cartridge having the set of parameters and algorithms; and
provide the template cartridge to the intelligent performance assistant light agent.

30. The system of claim 23 wherein the intelligent performance assistant routine is configured to provide operational cartridges about the performance of the set of parameters and algorithms utilized to solve for the solution.

31. The system of claim 30 comprising:
a robot computer system coupled to the simulation computer system and the knowledge computer system via the network, wherein the robot computer system comprises:
a processor; and
memory coupled to the processor and having an intelligent performance assistant robot routine executable by the processor and configured to:
obtain operational cartridges from the intelligent performance assistant light agent; and
provide the operational cartridges to the intelligent performance assistant factory routine; and
wherein the intelligent performance assistant factory routine is further configured to:
sort the set of parameters and algorithms with other sets of parameters and algorithms; and
create updated template cartridges that are accessible by the intelligent performance assistant light agent.

32. The system of claim 23 wherein hydrocarbons are produced based on the provided solution.

33. A simulation method comprising:
initializing a software program to simulate performance of a physical system;
selecting a set of parameters and algorithms for the software program with an intelligent performance assistant to enhance runtime performance of the simulation of the physical system;
solving equations in the software program with the set of parameters and algorithms;
storing a solution to the equations; and
producing hydrocarbons based on the stored solution.

34. The method of claim 33 wherein the intelligent performance assistant selects the set of parameters and algorithms without user intervention.

35. The method of claim 33 wherein the software program models fluid flow from a subsurface reservoir through one or more wells to a surface facility.

36. The method of claim 33 further comprising automatically adjusting the set of parameters and algorithms with a replacement set of parameters and algorithms when the set of parameters and algorithms is below a performance threshold.

37. The method of claim 33 wherein the intelligent performance assistant comprises an intelligent performance assistant light agent that is configured to:
receive information about a task;
provide the set of parameters and algorithms based on the information about the task.

38. The method of claim 37 wherein the intelligent performance assistant comprises an intelligent performance assistant factory that is configured to:
obtain performance measurements from previous simulations to create a template cartridge having the set of parameters and algorithms; and
provide the template cartridge to the intelligent performance assistant light agent.

39. The method of claim 33 wherein the intelligent performance assistant comprises an intelligent performance assistant light agent that provides operational cartridges about the performance of the set of parameters and algorithms in solving the solution.

40. The method of claim 39 wherein the intelligent performance assistant comprises:
an intelligent performance assistant robot and an intelligent performance assistant factory, wherein the intelligent performance assistant robot is configured to:
obtain operational cartridges from the intelligent performance assistant light agent; and
provide the operational cartridges to the intelligent performance assistant factory; and
the intelligent performance assistant factory is configured to:
sort the set of parameters and algorithms with other sets of parameters and algorithms; and
create updated template cartridges for the intelligent performance assistant light agent to access.

41. A method of simulating fluid flow comprising:
initializing a model in a simulator;
providing a set of parameters and algorithms to optimize runtime performance of a matrix solver method in a simulation,
wherein the set of parameters and algorithms is selected based on a correlation between parameters that describe a numerical matrix equation and performance of the set of parameters and algorithms in comparison to a plurality of sets of algorithms and parameters used to solve the numerical matrix equation;
simulating fluid flow in the model through a plurality of time steps, wherein at least one of the plurality of time steps generates the numerical matrix equation to be solved using the set of parameters and algorithms;
providing the solution to the simulation.

42. The method of claim 41 wherein the intelligent performance assistant obtains the set of parameters and algorithms without user intervention.

43. The method of claim 41 wherein the simulation models fluid flow through porous media from a subsurface reservoir through one or more wells to a surface facility.

44. The method of claim 41 further comprising interacting with the intelligent performance assistant to provide the computational fluid dynamics simulation with a different set of parameters and algorithms that enhance the runtime performance of the computational fluid dynamics simulation.

45. The method of claim 41 further comprising automatically adjusting the set of parameters and algorithms with a replacement set of parameters and algorithms when the runtime performance of the set of parameters and algorithms is below a specified threshold.

46. The method of claim 41 further comprising displaying the solution on a graphical user interface.

47. The method of claim 41 wherein the intelligent performance assistant comprises an intelligent performance assistant light agent configured to:
receive information about a task; and
provide the set of parameters and algorithms based on the information about the task.

48. The method of claim 47 wherein the information about the task comprises one of model descriptors, machine descriptors, simulation descriptors, numerical matrixes properties of the at least one numerical matrix solved in time steps of the computational fluid dynamics simulation, and any combination thereof.

49. The method of claim 47 wherein the information about the task comprises raw runtime performance data gathered during the computational fluid dynamics simulation.

50. The method of claim 47 wherein the information about the task comprises one of solver preconditioners, transformation methods, tolerances and any combination thereof.

51. The method of claim 47 wherein the information about the task comprises one of relative preset ratings, weights, selection probabilities, and any combination thereof.

52. The method of claim 47 wherein the intelligent performance assistant comprises an intelligent performance assistant factory that is a preprogrammed software module configured to:
utilize performance measurements from previous simulations to create a template cartridge having the set of parameters and algorithms; and
provide the template cartridge to the intelligent performance assistant light agent.

53. The method of claim 41 wherein the intelligent performance assistant comprises a persistent storage mechanism having runtime performance data for a plurality of sets of parameters and algorithms, wherein the runtime performance data comprises a weighted analysis of each of the sets of parameters and algorithms.

54. The method of claim 41 further comprising interfacing with the intelligent performance assistant to report runtime performance data on the set of parameters and algorithms and receive suggestions on other sets of parameters and algorithms to use in the solving of the equations.

55. The method of claim 41 further comprising interacting with the intelligent performance assistant to obtain runtime performance measurements from previous simulations to create a template cartridge having the set of parameters and algorithms; and to provide the template cartridge to the intelligent performance assistant.

56. The method of claim 41 wherein the intelligent performance assistant comprises a mechanism to collect runtime performance data from the computational fluid dynamics simulation.

57. The method of claim 41 wherein the intelligent performance assistant comprises an intelligent performance assistant light agent that provides operational cartridges about the performance of the set of parameters and algorithms in solving the solution.

58. The method of claim 57 wherein the intelligent performance assistant comprises:
an intelligent performance assistant robot and an intelligent performance assistant factory that are preprogrammed software modules, wherein the intelligent performance assistant robot is configured to:
obtain operational cartridges from the intelligent performance assistant light agent; and
provide the operational cartridges to the intelligent performance assistant factory; and
the intelligent performance assistant factory is configured to:
sort the set of parameters and algorithms with other sets of parameters and algorithms; and
create updated template cartridges for the intelligent performance assistant light agent to access.

59. The method of claim 41 comprising producing hydrocarbons based on the displayed solution.

60. The method of claim 41 wherein the runtime performance comprises computational time associated with a linear solve of the at least one numerical matrix at a specific time-step.

61. The method of claim 41 wherein the runtime performance comprises computational time associated with the entire computational fluid dynamics simulation.

62. The method of claim 41 wherein the runtime performance comprises a measurement of the quality of the solution.

63. A computer implemented simulation method comprising:
initializing a simulator;
utilizing an intelligent performance assistant to select a set of parameters and algorithms for the simulator;
solving equations with the set of parameters and algorithms; and
displaying a solution to the equations.

64. The method of claim 63 wherein the intelligent performance assistant selects the set of parameters and algorithms without user intervention.

65. The method of claim 63 further comprising interacting with the intelligent performance assistant to provide the simulator with a different set of parameters and algorithms that enhance the runtime speed of the solving the equations.

66. The method of claim 63 further comprising automatically adjusting the set of parameters and algorithms with a replacement set of parameters and algorithms when runtime performance of the set of parameters and algorithms is below a specified threshold.
